(19) United States
(12) Patent Application Publication
(10) Pub. No.: US 2012/0205473 A1
(43) Pub. Date: Aug. 16, 2012

(54) KNIFE FOR A SHREDDING MACHINE, AND USE OF SUCH A KNIFE IN A SHREDDING MACHINE

(76) Inventor: Martin Friz, Stuttgart (DE)

(21) Appl. No.: 13/384,444

(22) PCT Filed: Jul. 16, 2010
(86) PCT No.: PCT/EP2010/004346

§ 371 Date: May 1, 2012

(30) Foreign Application Priority Data
Jul. 16, 2009 (DE) 10 2009 033 584.6

(51) Int. Cl. B02C 18/18

(52) U.S. Cl. 241/29; 241/291

(57) ABSTRACT

A knife that can be used as a shredding tool for a shredding roll or as a stationary knife for a shredding machine. Grooves are provided within lateral surfaces connecting the main surfaces of said knife, said grooves forming recessed sections of a cutting edge at the cutting points with the main surfaces.

The invention relates to a knife for a shredding machine and the use of such a knife in a shredding machine.

Shredding machines having a rotor fitted with knives are used to shred waste such as offal timber, wood from building demolition, plastics products such as bumpers, when residual materials are produced from wood and plastics, packaging, paper, data carriers etc. The knives of the rotor work either only against the material to be shredded or against a counter knife, the contour of which is adapted to the clear contour of the rotating rotor in such a way that the counter knife forms cutting gaps together with the knives of the rotor, or both. Machines of this type can be used to shred irregular waste material into granular material with a predetermined grain size.

The known knives include, for example, those in which the main faces are of a spherical concave construction, resulting in points at the corners of the knife which are then adjoined by arcuate cutting edges produced by the intersection of the main face with the adjacent lateral faces. Knives of this type can also be used for the effective shredding of tough materials, since the respectively protruding corner of the knife is able to penetrate the material like a spike.

It has now been found that the shredding capacity of shredding machines fitted with knives of this type can be improved quite considerably by providing a groove arrangement in at least one of the lateral faces of the knife. At the cutting edges of the knife, these grooves produce a local geometry of the cutting edge which, on the one hand, increases the effective length of the cutting edge and, on the other, creates additional points which can act on the material in order to pierce it or entrain it with force fit (moving knife) or hold it fast (fixed knife).

A corresponding knife is the subject matter of Claim 1.

The idea of lengthening the cutting edge by providing grooves arranged in lateral faces of the knife and additionally creating points can also be applied in a counter knife which cooperates with a rotor.

Advantageous further developments of the invention are revealed in subclaims.

The knives for shredding rotors are conventionally constructed and mounted so that two lateral faces protrude beyond the circumferential face of the rotor core and cooperate with the shredding material and optionally with a counter knife in order to split, cut or mill the shredding material. It is therefore possible to frequently change the knives to position as yet unused cutting edges such that they protrude beyond the rotor core. In a knife according to Claim 2, there are at least two lateral faces of this type, each having a groove arrangement, which can be used successively.

If two spaced lateral faces are selected here as lateral faces provided with a groove arrangement, a square prismatic knife body always has in each case a working cutting edge with the above-mentioned local geometry and an adjacent cutting edge without a local geometry of this type. The latter then operates predominantly in the manner of shears so that the rotor both cuts easily cuttable material and firstly pierces poorly cuttable material, then splits and/or cuts it.

If two adjacent faces are selected as faces provided with a groove arrangement, the knives on the rotor can be changed over in each case so that the respectively active cutting edges both have a local structure or (optionally) neither has a local structure.

A knife, as indicated in Claim 3, always exhibits cutting edges provided with a local structure in any change of position.

A knife according to Claim 4 has local structures distributed over its length.

In a knife body according to Claim 5, these local structures are also maintained during resharpening by removing material at the main faces. With this, the edges formed by the intersections between the grooves and the lateral faces form further cutting edges which, if inclined, can cooperate with a counter knife under the same geometrical cutting conditions.

In a knife according to Claim 6, the secondary cutting edges produced by the intersection between the grooves and the lateral faces cooperate with cutting edges of a counter knife at a different cutting angle.

With the further development of the invention according to Claim 7, it is also possible for the properties of the cutting edges having a local structure to differ in some areas to enable optimum cutting conditions for different materials to be taken into equal account.

The further development of the invention according to Claim 8 is advantageous with regard to the construction of points at the ends of the cutting edges and at the ends of the grooves of the groove arrangement.

By increasing the number of concave sub-regions of the main face, it is possible here to increase the number of cutting points obtained at the cutting edges.

The further development of the invention according to Claim 9 is advantageous in terms of a long useful life of the cutting edges and their local structure.

If the knife is a counter knife, the advantages mentioned above for a rotor knife are also achieved for the counter knife. This is because the shredding procedures do not depend on the absolute movement but on the relative movement between the shredding material and knife or counter knife.

According to Claim 11 and the following, some or all of the lateral faces of the knives and counter knife in a cutting machine can be provided with a groove arrangement. Cooperation between lateral faces of knives and counter knife having the same groove-geometry arrangement is preferably avoided to prevent the material from jamming and to ensure a shear-like cutting geometry.

The invention is explained in more detail below with the aid of exemplary embodiments and with reference to the drawing, which shows:

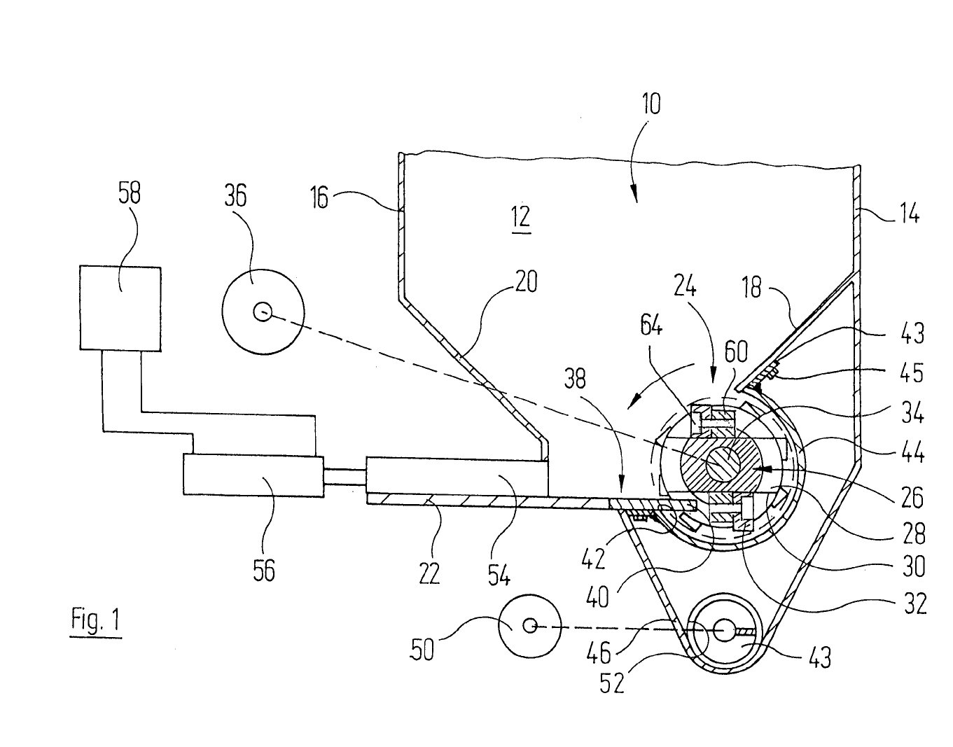

FIG. 1 a schematic vertical central section through a shredding machine having a rotor fitted with knives and a counter knife cooperating with the rotor;

FIG. 2 a plan view of part of the rotor fitted with knives and of the counter knife on an enlarged scale;

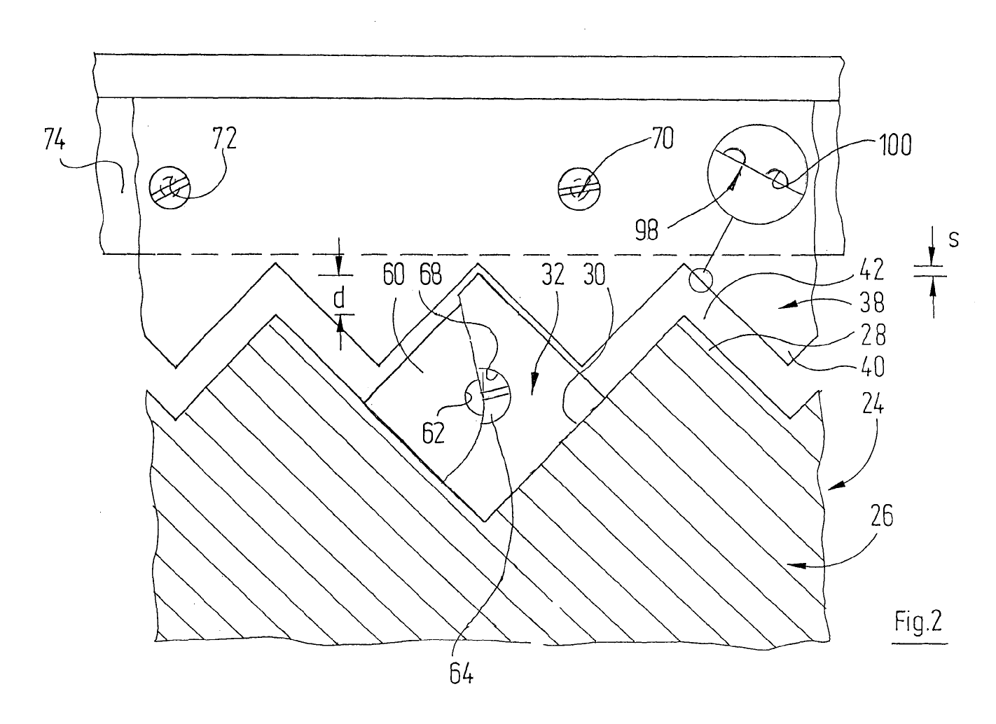

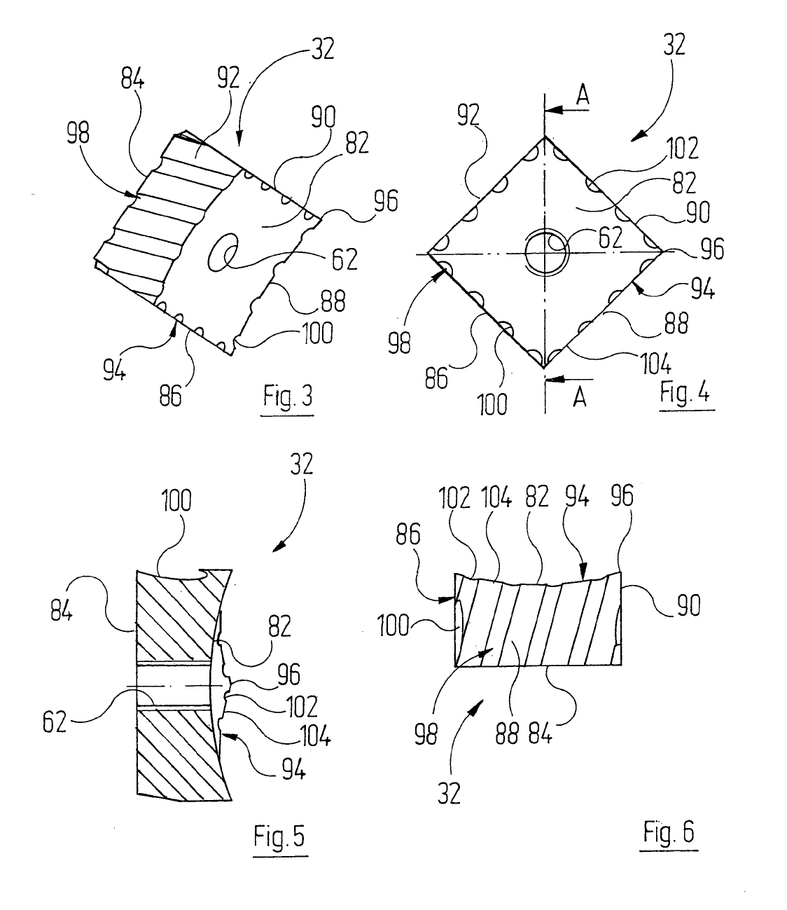

FIG. 3 a perspective illustration of a knife as used on the rotor of the machine according to FIG. 1;

FIG. 4 a plan view of the knife according to FIG. 3;

FIG. 5 a diagonal section through the knife according to FIG. 3 along the section line A-A therein;

FIG. 6 a side view of the knife according to FIG. 3;

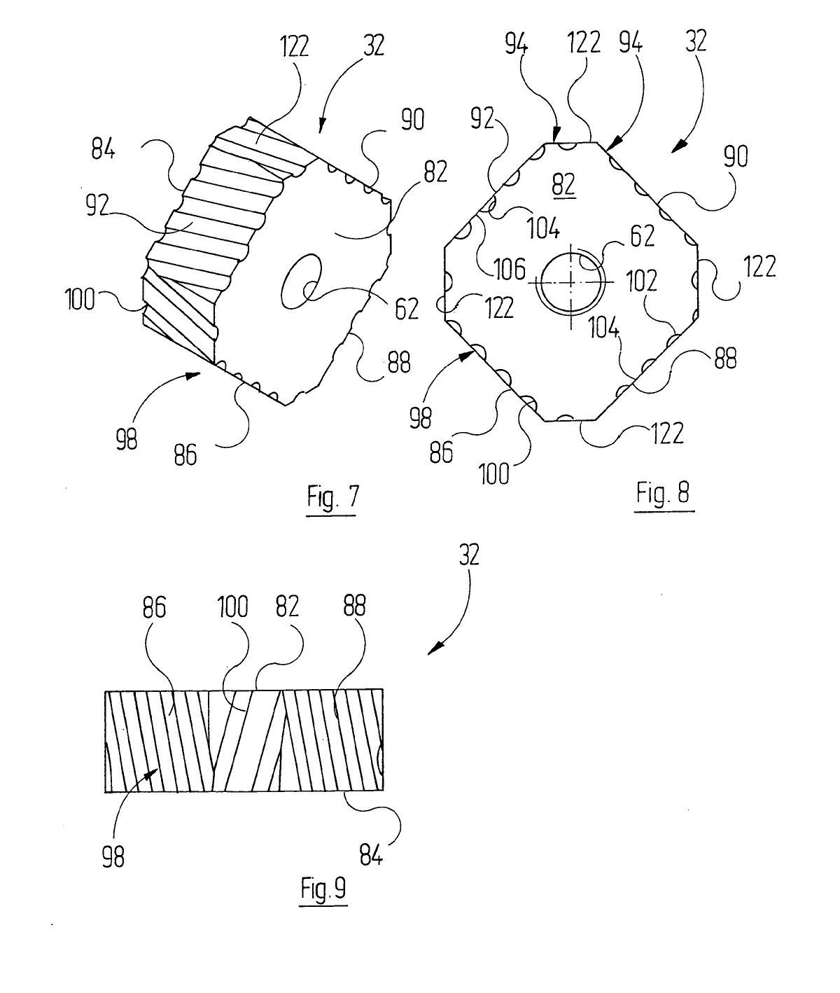

FIG. 7 a perspective illustration of a further knife, which can be used on the rotor of the machine according to FIG. 1;

FIG. 8 a plan view of the knife according to FIG. 7;

FIG. 9 a side view of the knife according to FIG. 7;

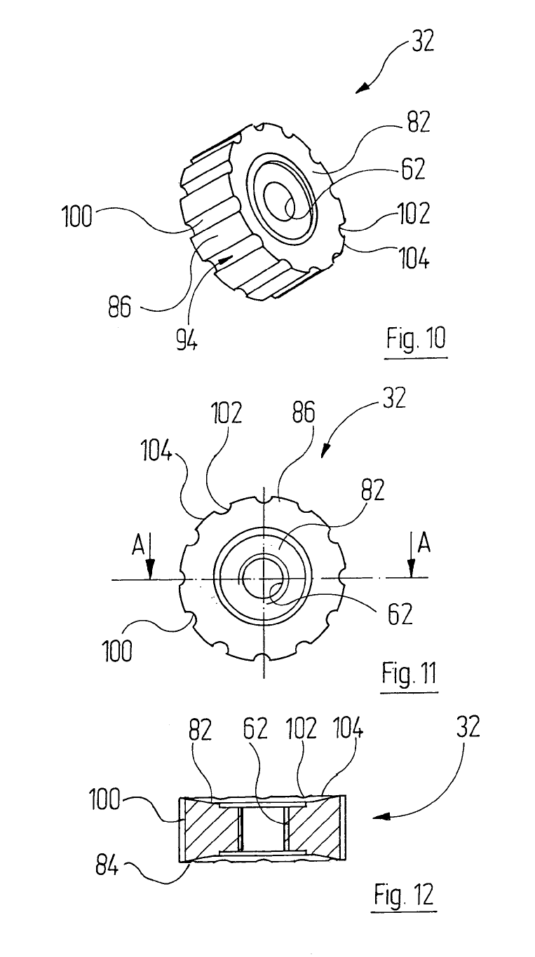

FIG. 10 a perspective illustration of a further knife as can also be used on the rotor of the machine according to FIG. 1 (optionally together with a a complementary counter knife);

FIG. 11 a plan view of the knife according to FIG. 10;

FIG. 12 a diagonal section through the knife according to FIG. 11 along the section line A-A therein;

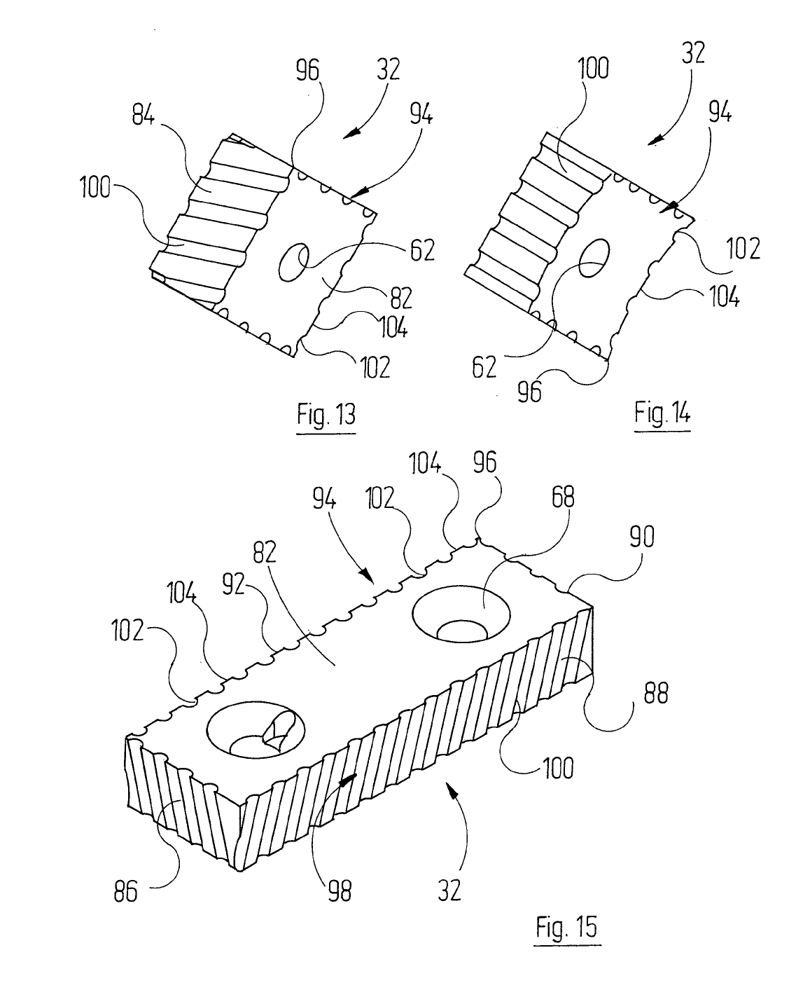

FIGS. 13 to 15 perspective illustrations of further modified knives for the shredding machine according to FIG. 1;

FIGS. 16 and 17 illustrations of knives in which further variants of the cutting edge design and the main face geometry are explained; and

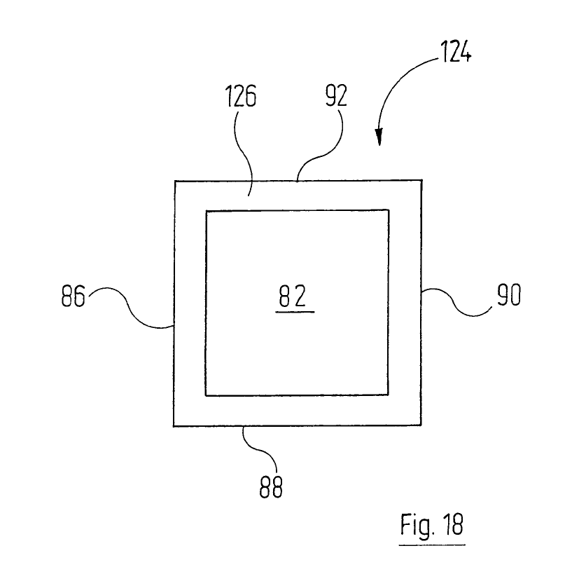

FIG. 18 a plan view of a knife body blank with hard metal edge regions.

In FIG. 1, a reservoir for waste to be shredded, such as residual wood or plastics materials, is denoted as a whole by 10. It has a rear wall 12, a front wall (broken away in the drawing) parallel to the rear wall, a right-hand wall 14 and a left-hand wall 16. The base of the reservoir 10 comprises two walls 18, 20 tapering towards one another and a horizontal base wall 22.

A shredding roller (denoted as a whole by 24) rotates below the lower end of the wall 18. This shredding roller has a roller base body 26 having a plurality of axially consecutive circumferential ribs 28. Two knife holders 30 are each incorporated at diametrically opposed points in the circumferential ribs, with the knife holders 30 of axially consecutive circumferential ribs each being offset from one another in the circumferential direction by a constant angular value, which is 45° in the illustrated exemplary embodiment, but is selected to be considerably smaller in practice, e.g. 15°.

Knife bodies 32 are seated in each case in the knife holders 30. Details relating to the manner in which the knife bodies 32 are secured are described more precisely below.

The roller base body 26 has stub shafts 34 which are integrally formed on its two end faces and run in bearings (not shown) which are supported by the rear and front wall of the reservoir 10. The shredding roller 24 is driven counter-clockwise by a geared motor 36, as indicated schematically in FIG. 1.

As can likewise be seen in FIG. 1, the central planes of the knife body 32 do not pass through the axis of the shredding roller 24, but are instead located upstream of the roller axis as seen in the operating direction of the shredding roller 24. It is thus ensured that the front cutting edges of the knife bodies 32 rotate about the roller axis at a larger spacing than the non-active cutting edges of the knife bodies 32, these latter cutting edges being at the rear as seen in the operating direction.

As can be seen in FIG. 1, the base wall 22 is offset downwards in relation to the axis of the shredding roller 24 and its free portion (positioned on the right in the drawing) is formed by a counter knife 38 which has, at the free end, teeth 40 between which clearances 42 remain. The entire arrangement is selected so that the knife bodies 33 can pass through the clearances 42 with a small degree of play d and a clearance s remains between the teeth 40 and the circumferential ribs 28, which clearance is greater than the working play between knife bodies 32 and counter knife 38, but small enough for large material pieces not to become jammed there.

A cylindrical perforated screen 44 over which the knife bodies 32 pass with a small degree of play is arranged around the shredding roller 24.

The perforated screen 44 is detachably mounted at its circumferential ends on the wall 18 and on the counter knife 38 (or a housing portion adjacent thereto) for example by means of brackets 43 and screws 45.

Provided below the perforated screen 44, there is a collecting channel 46 having a V-shaped cross-section in which a conveying screw 48 runs, which conveying screw is driven by a motor 50 as indicated schematically. The conveying screw 48 thus conveys shredded material from the collecting channel 46 into a delivery nozzle 52.

A box-shaped slide 54 may be moved over the base wall 22 by a double-acting hydraulic cylinder 56 which is in turn periodically acted upon with pressurised oil by a hydraulic unit 58 so that its piston rod extends and retracts. The slide 54 presses material lying on the base wall 22 into the engagement region between the shredding roller 24 and the counter knife 38.

The knife bodies 32 are mounted on the roller base body 26 using square prismatic knife carriers 60 which are welded into the knife holders 30 and are provided with a central threaded bore 62. A threaded bolt 64 which extends through a stepped bore 68 in the knife body 32 cooperates with said threaded bore.

The counter knife 38 is similarly connected to threaded bores 72 of a carrier 74 of the machine frame by threaded bolts 70.

As can be seen in FIG. 2, the knife bodies 32 mounted on the roller base body 26 are dimensioned such that the knife bodies 32 protrude radially over the circumferential ribs 28. This results in a narrow cutting gap between the cutting edges of the knife body 32 and the cutting edges of the counter knife 38. By comparison, the spacing between the cutting edges of the counter knife and the edges of the cross-sectionally triangular annular collars of the roller base body 26 in the clearances 42 is greater.

As can be seen in FIGS. 3 to 6, the knife body 32 has a front main face 82 (as seen in the direction of rotation) and a rear main face 84 (as seen in the direction of rotation) which, in plan view, are square. The main face 82 is spherically concave, as is likewise shown in the drawing, and the main face 84 is planar. The respective four edges of the main faces 82, 84 are connected by four lateral faces 86, 88, 90, 92 which together form a square prism.

An arcuate cutting edge 94 is produced in each case at the intersection points between the lateral faces and the main face 82, and a cutting point 96 is produced in each case at the interfaces between two adjacent cutting edges 94.

On the roller base body 26, a cutting point 96 and two adjacent cutting edges 94 protrude in each case over the clear contour of the roller base body 26 so that, when the shredding roller 24 rotates, they come into contact with the shredding material located in the reservoir 10 and form cutting gaps together with the teeth 40 of the counter knife 38.

A collection of grooves (denoted as a whole by 98) is provided in each case in the lateral faces 86, 88, 90, 92. This comprises individual grooves 100 which are arranged equidistantly and at the same setting angle over the lateral face and whereof the width and depth is considerably smaller than the length of the corresponding cutting edge 94. The width of the grooves 100 can typically be 1 to 7 mm, preferably approximately 2 to 5 mm, their depth being approximately 40% to 70% of the width, preferably approximately 50%.

The typical edge length of a knife body is between approximately 40 mm and approximately 100 mm.

The grooves 100 now form meandering cutting edges 94 together with the main faces 82, 84 and the lateral faces 86, 88, 90, 92, with smaller set-back edge portions 102 and longer linear edge portions 104 located between these latter. The edge portions 102 which lead away from the main extent of the edge are also described here as a local geometry of the cutting edge.

In the counter knife 38, which is shown in FIG. 2, the front main face is denoted by 106 and the rear main face by 108. The counter knife 38 has a strip-shaped base body 110 which is mounted on the machine frame and has teeth 40 positioned on the rotor side which have the form of an equilateral triangle with an included angle of 90° so that a zigzagging cutting edge 116 of the counter knife can pass the cutting edges 94 of a knife body 32 with a small radial play.

The cutting edge 116 is the intersection line between the main face 106 and lateral faces 118, 120 of the counter knife.

In the exemplary embodiment shown in FIG. 2, the lateral faces 118, 120 are continuously smooth so that the cutting edge 116 is composed of uninterrupted linear portions arranged in a zigzag.

In a modification of the exemplary embodiment described above, the lateral faces 118, 120 of the counter knife 38 can also be provided with a collection of grooves, as illustrated in magnified form in FIG. 2. With regard to the collections of grooves on the lateral faces 118, 120 of the counter knife 38 and their particular details, the same applies as for the collections of grooves which are provided on the lateral faces of the knife body 32.

The exemplary embodiment according to FIGS. 7 to 9 differs from that according to FIGS. 3 to 8 in that the main face 82 is planar and in that the points of the square are flattened by chamfered faces 122 which are likewise provided with a collection of grooves 98, the inclination of the grooves of the latter being opposed to the inclination of the grooves in the lateral faces 86, 88, 90, 92, as shown in FIG. 9.

In the exemplary embodiment according to FIGS. 10 to 12, the edge contour of the plan view is circular. There is only a single cylindrical circumferential face 86, which is provided with axially parallel grooves 100 distributed uniformly in the circumferential direction. Both main faces 82, 84 are concavely cup-shaped.

The exemplary embodiment according to FIG. 13 corresponds to that of FIG. 3, except for the main face 82 being planar.

The exemplary embodiment according to FIG. 14 corresponds to that of FIG. 3, except for the grooves 100 extending parallel to the knife axis.

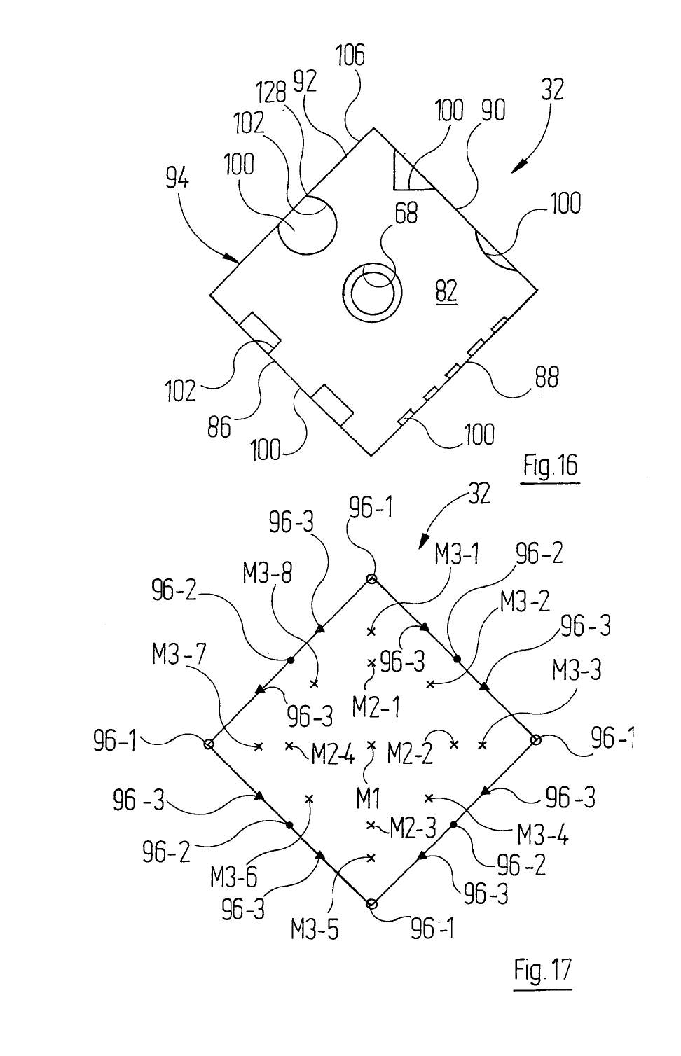

The exemplary embodiment according to FIG. 15 corresponds to that of FIG. 3, except for the main face 82 being rectangular and two stepped bores 68 being provided for receiving threaded bolts.

Further knife geometries which are not reproduced in the drawing include geometries which are triangular in plan view, particularly equilateral and equal-sided triangles.

FIG. 16 shows modified groove geometries which can be used alternatively for lateral faces of a knife body or a counter knife.

In the exemplary embodiment according to FIG. 16, the grooves 100 on the left-hand lower lateral face 86 are arranged at a greater spacing from one another and are deeper, and the grooves 100 in the right-hand lower lateral face 88 are arranged at a smaller spacing from one another and are shallower.

The grooves 100 in the right-hand upper lateral face 90 do not have a rectangular cross-section but a circular-segment shaped cross-section and a triangular cross-section. Their depth is sometimes also greater.

In the left-hand upper lateral face 92, there is a groove 100 having a circular-segment shaped cross-section, with the centre point of the circle being inwardly offset from the lateral face to produce wedge-shaped cutting edges 128 on the groove edge.

Other groove cross-sections and other groove spacings are also conceivable.

Also, the grooves do not have to extend over the entire height of a lateral face. In knife bodies which are not used, it is possible for the grooves to only extend over part of the lateral faces to the front main face as seen in the direction of rotation.

With reference to FIG. 17, it is now explained how the number of cutting points 96 can be increased.

In FIG. 17, M1 denotes the penetration point through the plane of the drawing of the axis of the spherical cup of the main face 82 of FIG. 3 and 96-1 denotes the cutting points produced by this main-face geometry. The latter are indicated by small unshaded circles.

In FIG. 17, M2 denotes the penetration points through the plane of the drawing of the axes of four spherical cups with half the diameter of the spherical cup of M1, which form sub-regions of the main face 82. 96-2 denotes additional cutting points produced by this main-face geometry. These cutting points are indicated by small filled-in circles.

In FIG. 17, M3 furthermore denotes the penetration points through the plane of the drawing of the axes of eight spherical cups with a third of the diameter of the spherical cups of M1, and 96-3 denotes the cutting points produced by this main-face geometry. These cutting edges are indicated by small filled-in triangles.

As shown, designing the main face 82 with four spherical cups having the centre points M2-1 to M2-4 results in four additional cutting points 96-2 which add to the cutting points 96-1, and designing the main face with eight spherical cups having the centre points M3-1 to M3-8 results in eight additional cutting points 96-3 which add to the cutting points 96-1.

If desired, it is possible to smooth that region of the main face which is located within the polygon delimited by the centre point M2-i or M3-i (i=1, 2, 3, . . . ) and replace it for example with the corresponding inner region of the spherical cup at the centre point M1.

This increase in the cutting points by increasing the number of spherical cups can also be implemented independently of providing grooves in lateral faces of the knife body.

In the exemplary embodiment according to FIG. 18, a knife body blank 124 is shown which is provided with soldered strip-shaped hard metal inserts 126 along the edges.

The grinding of the main faces of the knife body and the incorporation of the grooves 100 takes place in a knife body of this type after the hard metal inserts 126 have been applied.

Instead of hard metal inserts, it is also possible to use local hard facings which are incorporated in previously generated notches in the base body.

1. A knife for use as a shredding tool of a shredding roller or as a counter knife to a shredding roller, having comprising:
a base body which has mutually opposing main faces and lateral faces connecting the free edges thereof,
wherein at least one intersection line between at least one main face and at least one lateral face forms a cutting edge, wherein
at least one of the lateral faces has a groove arrangement extending to a cutting edge.

2. A knife according to claim 1, wherein at least two mutually spaced lateral faces have a groove arrangement.

3. A knife according to claim 1, wherein a groove arrangement is provided in all lateral faces.

4. A knife according to claim 1, wherein a groove arrangement has in each case a plurality of spaced grooves.

5. A knife according to claim 4, wherein the grooves of a groove arrangement have the same inclination.

6. A knife according to claim 4, wherein the grooves of different groove arrangements have a different inclination and/or different spacing from one another.

7. A knife according to claim 4, wherein the grooves include some with a different cross-sectional geometry and/or different size of cross-section.

8. A knife according to claim 1, wherein at least one of the main faces in one or multiple regions is concave.

9. A knife according to claim 1, wherein the cutting edges which are produced by the main faces and the lateral faces are located at least partially on a hard metal layer formed by a knife insert or a hard facing.

10. The use of the knife according to claim 1 in a shredding machine, comprising:
a shredding roller fitted with knives and
a counter knife cooperating with the knives of the shredding roller, the teeth of which counter knife are adapted to the geometry of the clear contour of the rotating shredding roller, characterised in that at least some of the knives of the shredding roller have at least one lateral face which is provided with a groove arrangement (98).

11. A use according to claim 10, wherein all the knives of the shredding roller have at least one lateral face which is provided with a groove arrangement.

12. A use according to claim 10, wherein at least some of the teeth of the counter knife have at least one lateral face which is provided with a groove arrangement.

13. A use according to claim 12, wherein only the lateral faces of teeth of the counter knife which cooperate with groove-free lateral faces of knives are provided with a groove arrangement.

14. A use according to claim 12, wherein lateral faces of teeth of the counter knife which cooperate with grooved lateral faces of knives of the shredding roller have a groove arrangement which differs geometrically from that of the knives of the shredding roller.
